(19) United States
(12) Patent Application Publication
(10) Pub. No.: US 2024/0401666 A1
(43) Pub. Date: Dec. 5, 2024

(54) TIRE TESTING MACHINE WITH VIBRATION DAMPER

(71) Applicant: ILLINOIS TOOL WORKS INC., Glenview, IL (US)

(72) Inventors: Anders Maki, Norwood Young America, MN (US); Richard Amy, Eden Prairie, MN (US); Paul Carroll, Eden Prairie, MN (US); Dave Pankratz, Eden Prairie, MN (US); Byron John Saari, Minneapolis, MN (US)

(21) Appl. No.: 18/677,420

(22) Filed: May 29, 2024

Related U.S. Application Data
(60) Provisional application No. 63/504,952, filed on May 30, 2023.

(51) Int. Cl. F16F 15/02; F16F 7/10; F16F 7/108; G01M 17/013; G01M 17/02

(52) U.S. Cl. CPC F16F 15/02; F16F 7/1005; F16F 7/108; G01M 17/013; G01M 17/022; F16F 2222/08; F16F 2228/066; F16F 2230/08; F16F 2230/18; F16F 2234/02

(57) ABSTRACT

In one aspect, a vibration damper includes first and second diaphragm flexures defining a cavity therebetween, a damping material disposed in the cavity, and a mass connecting the first and second diaphragm flexures. In another aspect, an assembly includes a load cell body having two opposed sides, a first vibration damper operably connected to the load cell body at the first side and a second vibration damper operably connected to the load cell body. In yet other aspects, a machine are method are used to test a tire and wheel assembly, wherein the machine includes a road surface simulator, a spindle hub, a spindle housing, a frame, a spindle support, and a damper assembly. The damper assembly is joined to the spindle housing or to the spindle support and is configured to attenuate forces or motions of the spindle hub or the spindle support.

### CROSS REFERENCE TO RELATED APPLICATIONS

This application claims the benefit of priority from U.S. Provisional Patent Application No. 63/504,952 filed May 30, 2023 for “Tire Testing Machine with Vibration Damper,” the content of which is hereby incorporated by reference.

### BACKGROUND

The discussion below is merely provided for general background information and is not intended to be used as an aid in determining the scope of the claimed subject matter. Aspects of the present disclosure relate to a tire and wheel testing machine having a vibration damping assembly.

For testing of a tire and wheel assembly on a machine with a simulated roadway, forces between the contact patch of the tire and the roadway surface can be measured by a load cell carried by the machine near a spindle hub on which the tire and wheel are mounted. A load cell transmits and measures linear forces along, and moments about, up to three orthogonal axes.

Two such load cells are disclosed in commonly owned U.S. Pat. No. 4,640,138, entitled “Multiple axis load sensitive transducer” and U.S. Pat. No. 4,821,582, entitled “Load transducer,” which are hereby incorporated by reference. U.S. Pat. No. 4,640,138 describes a multiple axis load-sensitive transducer having inner and outer members that are joined by a pair of axially spaced spiders. The spiders comprise arms that are integral with the inner member and are connected to the outer member by flexible straps that have longitudinal links, with the ends of the straps fixed to the outer member. The arms of the spiders are fixed to the center of the associated strap. Loads are sensed as a function of bending on the spider arms. U.S. Pat. No. 4,821,582 describes a load transducer that measures linear forces in three axes and moments about two of the axes. The transducer has inner and outer structures connected by load-sensitive spider arms or shear beams. The outer ends of the spiders are connected to outer links that are stiff when the inner structure is loaded in a direction along an axis perpendicular to the plane of the spider. Each of the foregoing load cells can be affected adversely by vibrations and other forces transmitted to the load cell by the tire and wheel assembly on the simulated roadway. Excessive vibration can affect the accuracy and/or life span of the load cell.

### SUMMARY

In one aspect, a vibration damper comprises first and second diaphragm flexures defining a cavity therebetween, a damping material disposed in the cavity, and a mass connecting the first and second diaphragm flexures.

In another aspect, an assembly comprises a load cell body having two opposed sides, a first vibration damper operably connected to the load cell body at the first side and a second vibration damper operably connected to the load cell body.

In yet another aspect, a machine is configured to test a tire and wheel assembly, the machine comprising a road surface simulator, a spindle hub, a spindle housing, a frame, a spindle support, and a damper assembly. In an exemplary embodiment, the spindle hub is configured to support the tire and wheel assembly upon the road surface simulator. In an exemplary embodiment, the spindle housing supports the spindle hub for rotation about an axis. In an exemplary embodiment, the spindle support is joined to the frame and the spindle housing. In an exemplary embodiment, the damper assembly is joined to the spindle housing or to the spindle support and is configured to attenuate forces or motions of the spindle hub or the spindle support.

An exemplary method, of testing a tire and wheel assembly is described. An exemplary method comprises mounting the tire and wheel assembly on a spindle hub configured to support the tire and wheel assembly upon a road surface simulator, wherein a spindle housing supports the spindle hub for rotation about an axis, and wherein a spindle support is joined to the spindle housing. An exemplary method comprises operating the spindle hub to rotate the tire and wheel assembly against the road surface simulator. An exemplary method comprises mounting a damper to the spindle housing or to the spindle support to attenuate forces or motions of the tire and wheel assembly upon the road surface simulator.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. All descriptions are applicable to like and analogous structures throughout the several embodiments, unless otherwise specified.

FIG. 1 is a front perspective view of a tire testing machine with an exemplary embodiment of a tuned mass damper assembly.

FIG. 2 is a rear perspective view of the tire testing machine of FIG. 1.

FIG. 3 is a front elevation view of the tire testing machine without a tire, showing a first exemplary embodiment of a passive damper.

FIG. 4 is a front perspective view of the tire testing machine with a tire and wheel assembly mounted thereon, showing the first exemplary embodiment of a passive damper.

FIG. 5 is a partial rear and side perspective view of the hub end of the spindle drive assembly, showing the first exemplary embodiment of a passive damper mounted to a spindle housing holding a load cell body.

FIG. 6A is a vertical cross-sectional front view of the first exemplary embodiment of a passive damper.

FIG. 6B is a vertical cross-sectional side view of the first embodiment of a passive damper.

FIG. 6C is a vertical cross-sectional front view of a second embodiment of a passive damper.

FIG. 7A is a front elevation view of a tire testing machine with a third exemplary embodiment of a passive damper.

FIG. 7B is a side elevation view of a tire testing machine with the third exemplary embodiment of a passive damper (the front of the machine is on the left; the rear of the machine is on the right).

FIG. 8 is a partial cross-sectional view of the construction of a constrained layer lamination structure of the third exemplary embodiment of a passive damper.

FIG. 9 is a rear perspective view of a tire testing machine, similar to FIG. 2, with an additional exemplary embodiment of an active damper.

FIG. 10 is a side elevation view of a tire testing machine with the exemplary embodiment of an active damper (the rear of the machine is on the left; the front of the machine is on the right).

FIG. 11A is a schematic of a passive damper attached to a testing machine.

FIG. 11B is a schematic of a passive damper attached to a load cell.

FIG. 11C is a schematic of an active damper attached to a testing machine.

While the above-identified figures set forth one or more embodiments of a load transducer, other embodiments are also contemplated. This disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for case of understanding the description. It is contemplated that structures may be oriented otherwise.

The terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. Unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. The singular forms of “a,” “an,” and “the” include plural references unless the context clearly dictates otherwise.

### DETAILED DESCRIPTION

This disclosure describes exemplary embodiments of a tuned mass damper assembly that is especially suitable for use with a load cell and in the context of a tire testing machine. One particularly suitable machine is the FlatTrac® tire force and moment measurement system commercially available from MTS Systems of Eden Prairie, Minnesota. Another suitable system is described in commonly owned U.S. Pat. No. 6,584,835, entitled “Spindle Assembly for a Tire or Wheel Testing Machine,” which is hereby incorporated by reference. The described tuned mass damper assembly can also be used with other systems and with load cells in other applications. In an exemplary embodiment, a tuned mass damper assembly includes one or more of a passive damper and an active damper.

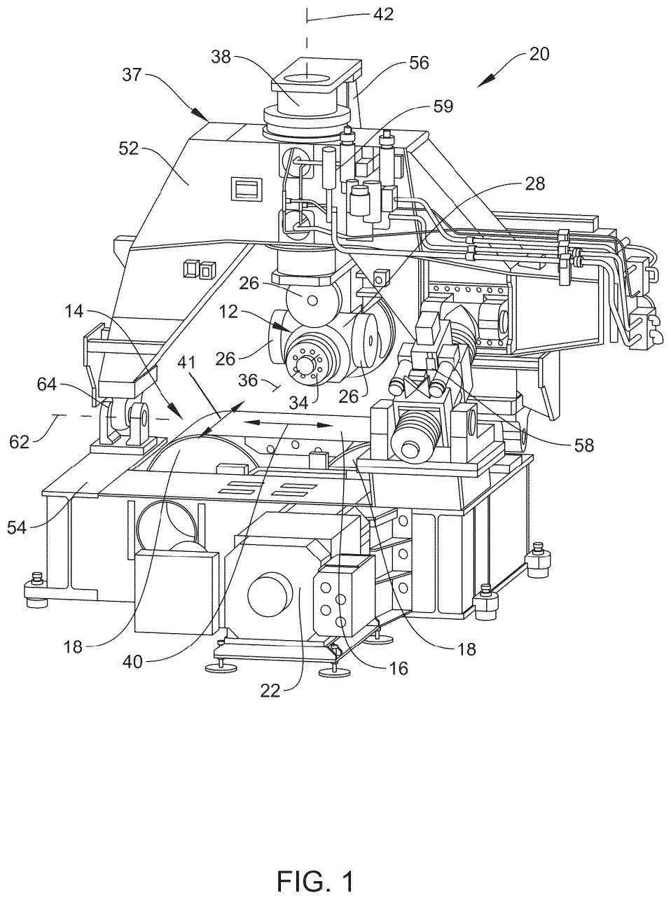

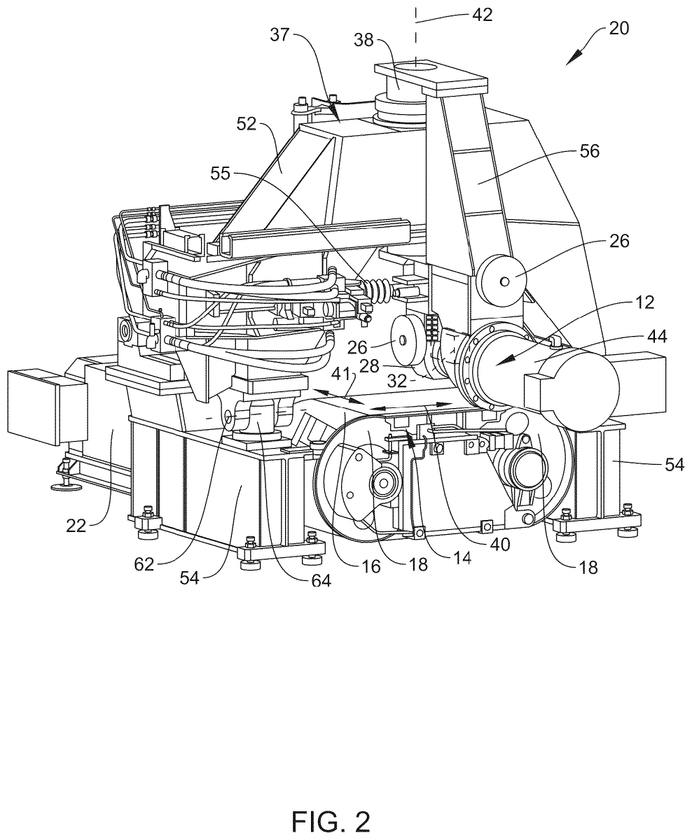

FIGS. 1 and 2 are front and rear perspective views, respectively, of a suitable tire and wheel testing machine 20 for use with the described tuned mass damper assembly. The illustrated tire and wheel testing machine 20 includes a spindle drive assembly 12 and a road surface simulator 14 comprising an endless belt 16 that forms a revolving surface. The endless belt 16 is supported on and rotates about a pair of rollers 18. A belt drive assembly 22 moves the endless belt 16, on which a tire and wheel assembly 24 are tested. As appreciated by those skilled in the art, other forms of revolving surfaces such as a rotatable drum can be used in place of the illustrated roadway simulator 14.

In an exemplary embodiment, the spindle drive assembly 12 includes a driven spindle shaft joined to a spindle hub 34. The spindle hub 34 is adapted to support the tire and wheel assembly 24 for rotation about a spindle axis 36. A drive motor 44 rotates the tire and wheel assembly 24 about the spindle axis 36.

In the illustrated embodiment, frame 37 of machine 20 includes a frame member 52 that is pivotally mounted with respect to base 54 at pivotal connection 64, allowing for adjustment the camber of the tire and wheel assembly 24 with respect to the road surface simulator 14. In an exemplary embodiment, a camber actuator 58 is coupled to the frame member 52 to displace the frame member 52 and spindle drive assembly 12 about a camber axis 62 extending through pivotal connection 64.

In an exemplary embodiment, frame 37 of machine 20 includes a support member 38 that turns the spindle hub 34 and spindle drive assembly 12 about a steer axis 42 that is typically oriented perpendicular to the spindle axis 36. In an exemplary embodiment, a linear steer actuator 55 is coupled to the frame member 52 and to a strongback or spindle support 56 that is pivotally attached to the frame member 52 to move about steer axis 42. The spindle support 56 is attached to and supports the spindle drive assembly 12 and spindle hub 34 to turn a tire and wheel assembly 24 about the steer axis 42. In other embodiments, a rotary actuator may be used for turning the support member 38 about the steer axis 42. In an exemplary embodiment, a vertically disposed linear actuator 59 is coupled to support member 38 to lift and lower (and transmit a vehicle weight simulating load to) tire and wheel assembly 24 relative to endless belt 16.

The construction of the frame member 52, its pivotal connection 64 to base 54, and the means for supporting and pivoting the spindle drive assembly 12 about the steer axis 42 and about the camber axis 62 pertaining to the exemplary embodiment should not be considered limiting. In an exemplary embodiment, actuators 55, 58 and 59 displace the spindle hub 34 and the spindle support 56 directly, or indirectly through other support structure, so as to displace and apply loads upon the tire as the tire rotates upon the revolving surface (such as endless belt 16); the spindle 34 and revolving surface can include independent drives. The actuating devices and support structure can take many forms to support the spindle 34 over the revolving surface and can include mechanical assemblies utilizing gears and/or electric, hydraulic and/or pneumatic actuators. One or more damping assemblies are provided to attenuate forces upon the spindle 34 due to forces generated between the tire and the revolving surface. Preferably, the damping assemblies are configured to provide damping along the axis of rotation of the spindle 34 and/or orthogonal to the axis of rotation of the spindle 34 (generally in the fore and aft direction 40—which is parallel to a surface 16 of the road surface simulator 14 in contact with the tire under test).

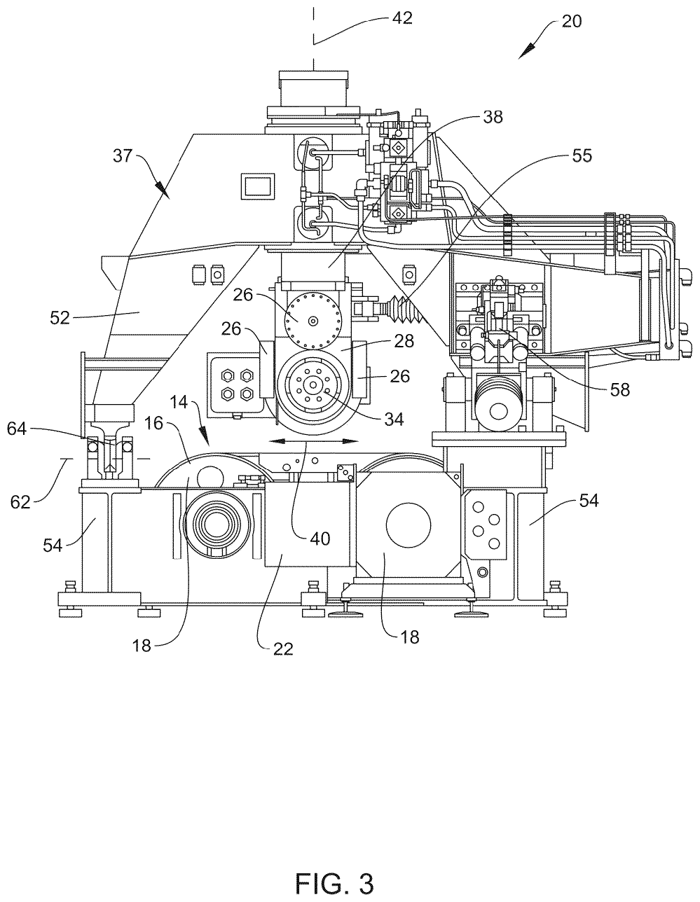

FIG. 3 is a front elevation view of a testing machine 20 with the tire and wheel assembly 24 removed therefrom so that the spindle hub 34 is visible. The two left and right passive dampers 26 attenuate vibrations in the fore and aft directions 40. These dampers 26 are preferably placed close in proximity to the spindle hub 34 such as being mounted to spindle housing 28 or to spindle support 56 to absorb vibrations and other forces transmitted from the tire and wheel assembly 24 to components of the testing machine 20. In an exemplary method for use of a passive damper 26, two such passive dampers 26 are mounted on left and right sides, respectively, of the spindle housing 28, which holds load cell 32, examples of which are mentioned in the Background but should not be considered limiting. Exemplary load cells are also disclosed in commonly owned U.S. Pat. No. 6,845,675, entitled “Multi-Axis Load Cell,” and U.S. Pat. Nos. 4,640,138; 4,821,582 and 6,845,675, which are hereby incorporated by reference in their entirety.

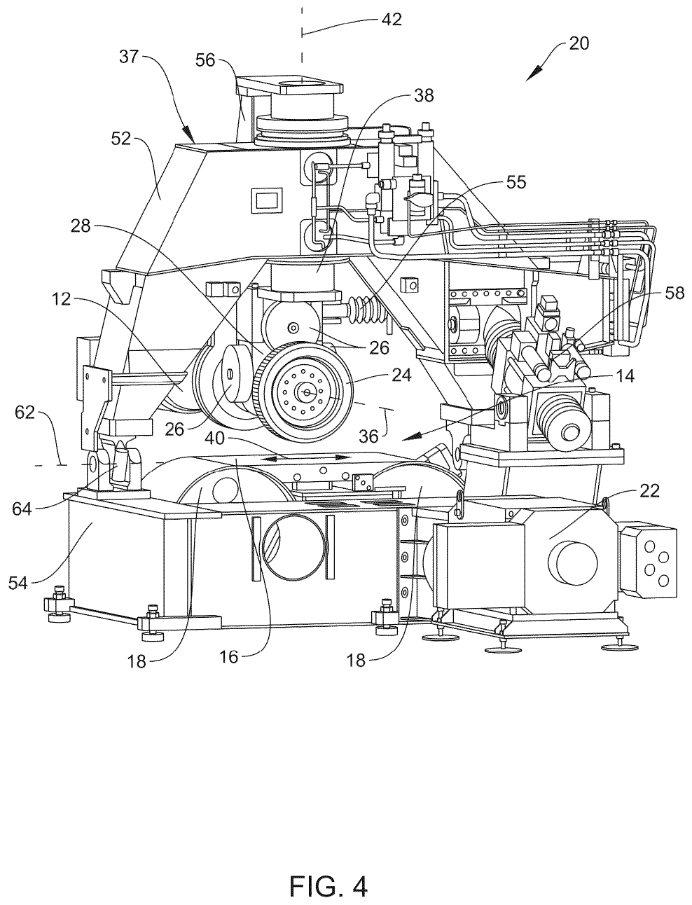

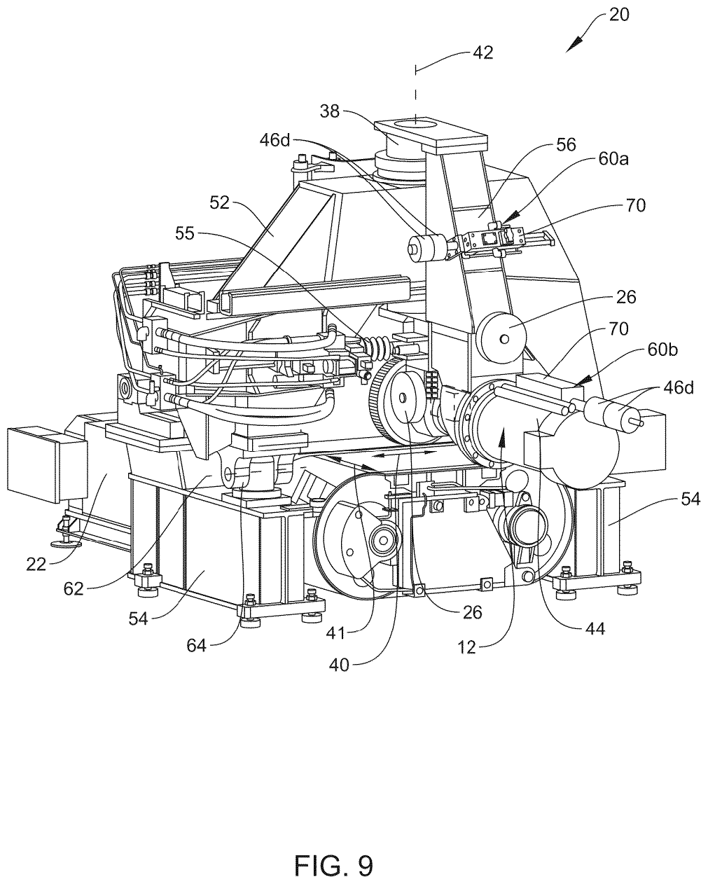

As shown in FIGS. 4 and 9, in an exemplary implementation, two (front and rear) passive dampers 26 are disposed on spindle support 56 to attenuate forces along the axis of rotation of the spindle 34 in direction 41 between the tire contact patch and the roadway simulator 14. In other implementations, any of the dampers described in this disclosure of a tuned mass damper assembly can be placed elsewhere on the machine 20, such as at other locations of the spindle drive assembly 12, or components attached to the drive assembly 12, such as spindle support 56, for example. By absorbing or otherwise attenuating vibrational and other forces, the disclosed tuned mass dampers protect components of the machine 20 from excessive loading that can contribute to wear and tear upon the machine 20.

In some instances, several embodiments of an element are shown. The element in general may be indicated by a reference number, and specific embodiments of the element may be indicated with lower case letter designations used with that reference number. In all cases, a discussion relevant to an element will refer to all other similarly numbered elements unless otherwise stated.

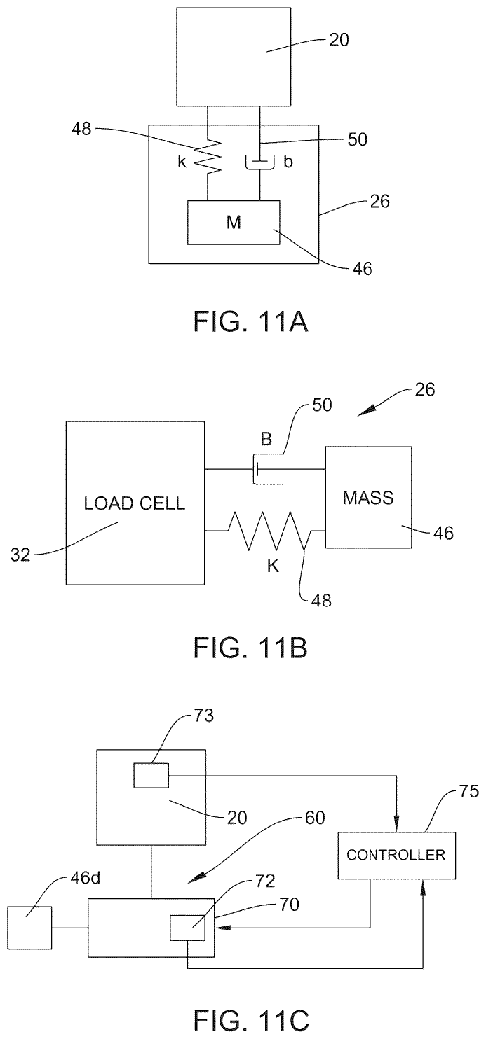

As shown in FIG. 11A, a schematically depicted passive damper 26 is attached to tire and wheel testing machine 20. As shown in FIG. 11B, a schematically depicted passive damper 26 is attached to load cell 32, which may be used in an implementation other than a tire and wheel testing machine. Such a passive damper 26 includes a mass 46 attached to a spring 48 (having a spring constant k) and a damper element 50 such as a damping material. A passive damper 26 having these components in any configuration can be used in the described tuned mass damper assembly with testing machine 20. This disclosure also includes specific structures such as a drum-shaped passive damper 26a, a drum-shaped constrained passive damper 26b and a constrained layer laminated passive damper 26c, for example. These specific embodiments are not limiting but are merely specific structures that are suitable as passive dampers.

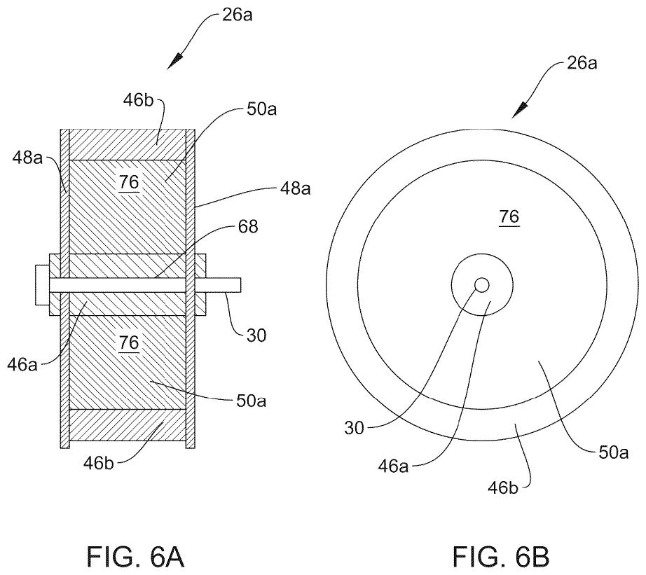

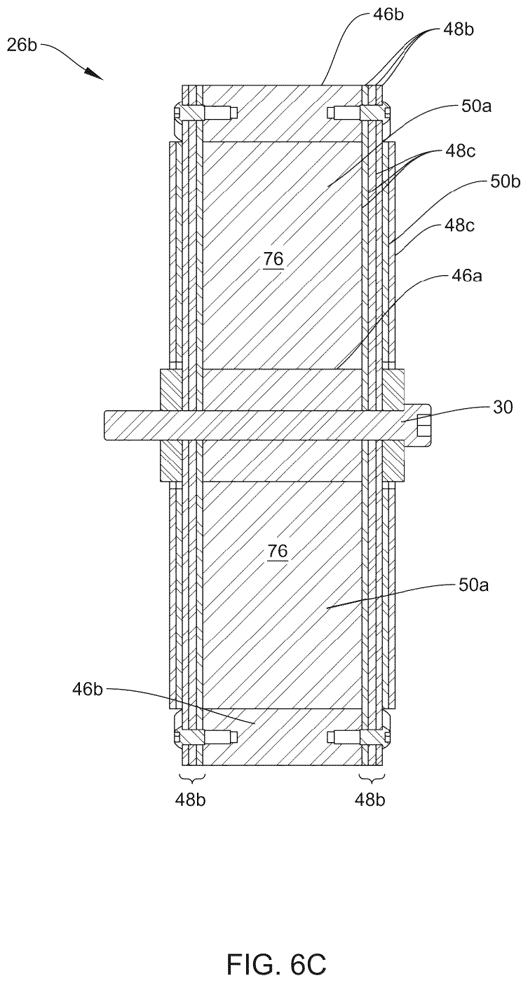

A configuration of the damping material 50 affects its behavior and performance. For example, referring to FIGS. 6A-6C, when particulate damping material 50a is formed as granular pellets (such as lead shot, for example), vibrations experience frictional damping as the particles rub against each other, thereby generating heat as a form of energy dissipation. In contrast, referring to FIG. 6C, a solid elastomer damping material 50b relies on inherent resilience properties for damping effects. Layered or stacked structures may exhibit Coulomb damping in which kinetic energy is absorbed via sliding friction generated by the relative motion of two surfaces that press against each other. A spring 48 may take many different forms, and a constrained layer construction 66 can serve both spring and damping functions.

As shown in FIGS. 1-6C, in exemplary embodiments, passive damper 26a, 26b is configured in a drum shape, wherein each substantially cylindrical unit is attached to the spindle housing 28 of spindle 34 by a fastener such as bolt 30. In an exemplary embodiment as shown in FIGS. 6A and 6B, a drum passive damper 26a, 26b is formed with a central shaft spacer mass 46a having a bore 68 therethrough for the passage of fastener 30. A concentric cylindrical mass 46b surrounds the shaft mass 46a. These elements are connected in an exemplary embodiment on opposing sides by a pair of circular diaphragm flexures 48a. In an exemplary embodiment, a cavity 76 between the two masses 46a, 46b and circular diaphragm flexures 48a is at least partially filled with a particulate damping material 50a such as lead shot.

FIG. 6C shows a variation of a drum-shaped passive damper 26b in which each of the circular diaphragm flexures 48a includes a stacked diaphragm 48b that exhibits Coulomb damping capabilities adjacent a constrained-layer damping lamination 66 (discussed below with respect to FIG. 8). The Coulomb damping stacked diaphragm 48b has of a plurality of layers, such as metallic layers 48c.

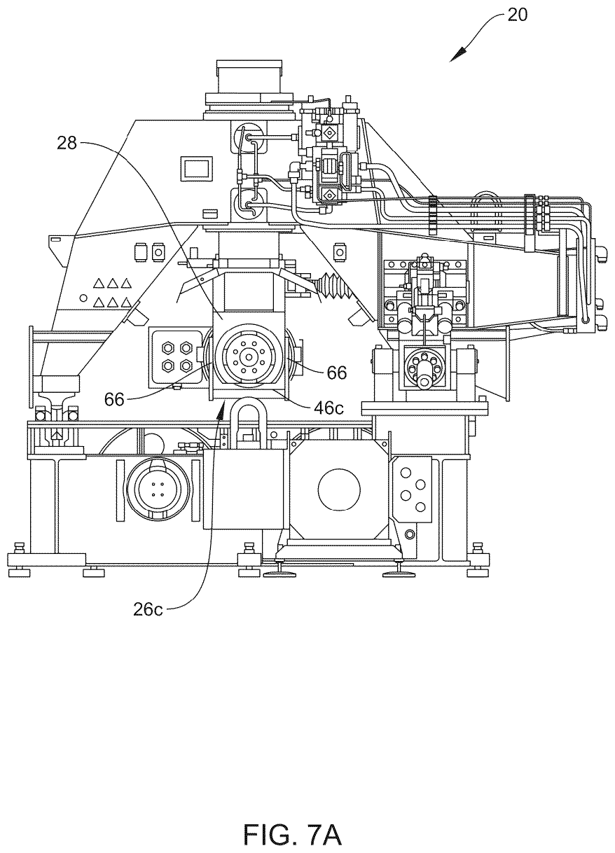

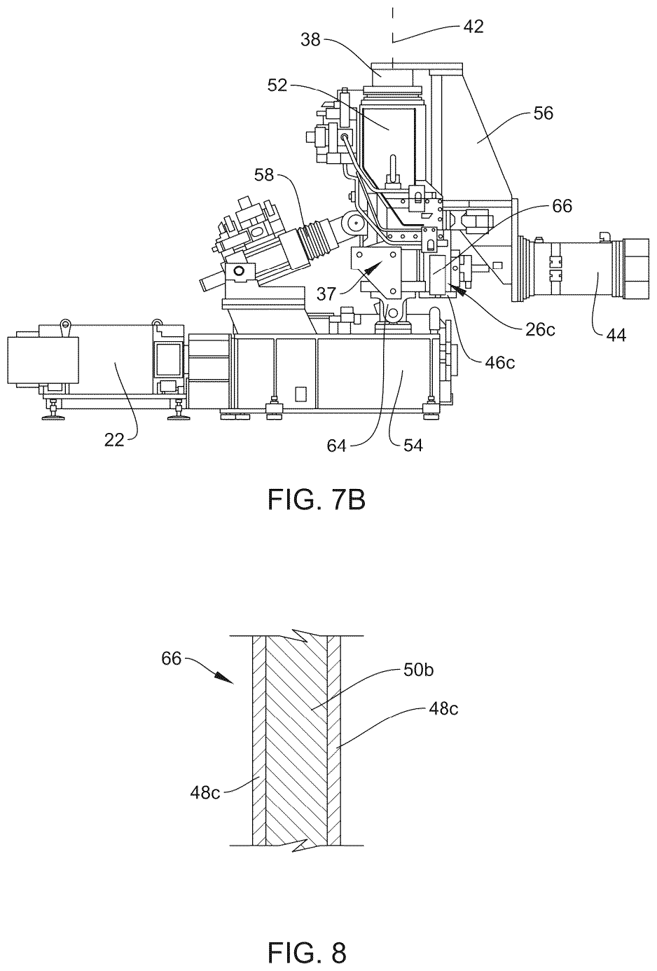

FIGS. 7A and 7B are front and side elevation views, respectively, of a tire and wheel testing machine 20 with a third exemplary embodiment of a passive damper thereon, namely one configured as a constrained layer passive damper 26c. In the illustrated embodiment, a bar mass 46c is attached by two laminated constrained layer structures 66 to left and right sides of spindle housing 28. In an exemplary embodiment, each of the constrained-layer damping laminations 66 is composed of several layers of material, a cross-sectional view of which is shown in FIG. 8. In an exemplary embodiment, lamination 66 includes a solid elastomer 50b (or other viscoelastic material) sandwiched between two flat metal springs 48c.

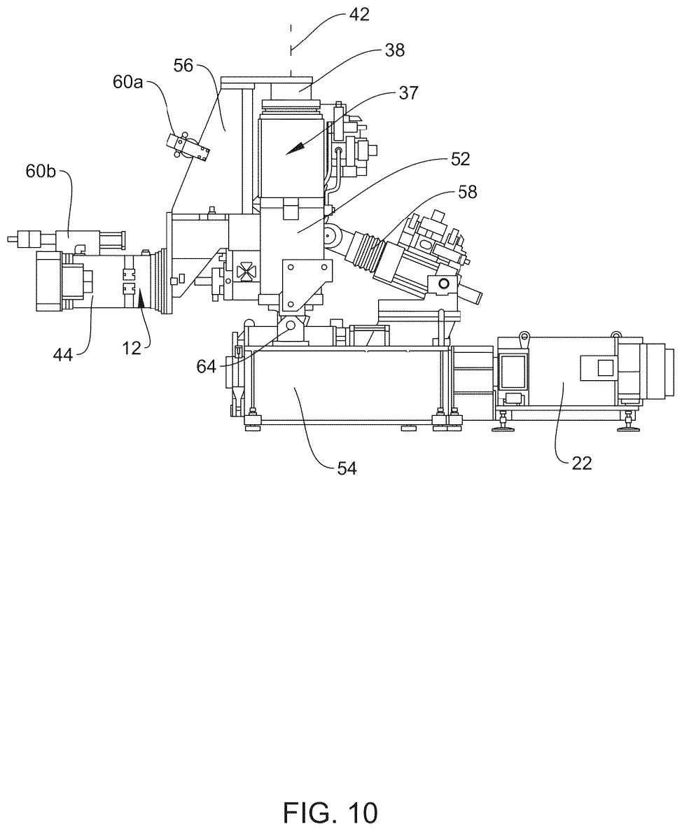

FIG. 9 is a side and rear perspective view of a tire testing machine 20 with several drum passive dampers 26 and active dampers 60a, 60b mounted thereon. FIG. 10 shows a side elevation views of a machine 20 with an active damper 60a mounted on spindle support 56 and an active damper 60b mounted on spindle drive assembly 12. As shown in FIGS. 9-10, in an exemplary embodiment, an active damper 60a is attached to spindle support 56 of machine 20 and is oriented so that actuation of mass 46d is accomplished in a generally horizontal direction that is orthogonal to the axis of rotation of the spindle 34 and calibrated to reduce vibrations generally in fore and aft direction 40. Another active damper 60b is attached to spindle drive assembly 12 and oriented so that actuation is accomplished along the axis of rotation of the spindle 34 and calibrated to reduce vibrations along the axis of rotation of the spindle 34 (generally a lateral motion 41 across the endless belt 16).

FIG. 11C shows a schematic of an active damper 60 configured for attachment to a portion of testing machine 20. In an exemplary embodiment, the active damper 60 includes an actuator 70 attached to mass 46d. Active damper 60 includes sensor 72 to sense motion of the mass 46d, while a sensor 73 senses motion of the portion of the testing machine 20. Signals from sensors 72 and 73 are used by a controller 75. As schematically shown, the controller 75 controls operation of the actuator 70 in a phased relationship with detected vibrations of the portion of the test machine 20, to thereby move the mass 46d to control the resonant frequencies of the part of machine 20 to which active damper 60 is attached. Sensors 72 and 73 may be any type of motion sensor that is able to detect motion of the mass 46d and portion of the test machine 20, respectively. Typically, each motion sensor 72, 73 is any one of a displacement sensor, velocity sensor or accelerometer. It should be understood that motion sensors 72 and 73 are schematically shown and do not necessarily represent their connection to the portion of the test machine 20 or the actuator 70. For instance, if embodied as an accelerometer, the motion sensor 72, 73 would be coupled to moving portions of the test machine 20 or the actuator 70 or mass 46d to sense acceleration. Whereas if embodied as a displacement or velocity sensor, sensor 72 or 73 would be configured to measure displacement or velocity of portion of the test machine 20, mass 46d or moving portions of actuator 70. Output signals from the motion sensors 72, 73 are provided to controller 75 that can include processing circuitry to yield displacement, velocity and/or acceleration values so as to control operation of the actuator 70 and move the mass 46d to attenuate forces and/or displacements of the portion of the test machine 20. Actuator 70 can be any active part configured to move mass 46d to counteract motion, such as an electric actuator or hydraulic or pneumatic cylinder, for example.

The illustrated placement of two passive dampers 26 on left and right sides of the spindle housing 28 results in a damping of forces that are orthogonal to the axis of rotation of the spindle 34 and are primarily in the fore and aft directions as shown by arrow 40. The illustrated placement of two passive dampers 26 on the front and rear of the spindle support 56 results in a damping of forces that are along the axis of rotation of the spindle 34 and primarily in the lateral directions as shown by arrow 41. The illustrated placement of an active damper 60a on spindle support 56, and oriented to move mass 46c in the fore and aft directions as shown by arrow 40 also attenuate vibrations orthogonal to the axis of rotation of the spindle 34. The illustrated placement of an active damper 60b on spindle assembly 12, and oriented to move mass 46c along the axis of rotation of the spindle 34 in the lateral directions as shown by arrow 41 also attenuate vibrations in that direction. It is to be understood that dampers 26, 60 can be placed in other positions and orientations, especially on spindle drive assembly 12 and/or spindle support 56, to damp forces in other directions (for example along the steer axis) on test machine 20, load cell 32, or another object to which the tuned mass damper assembly is attached.

The oscillation frequency of a passive damper 26 is tuned to be similar to the resonant frequency experienced by the part of the machine 20 to which it is mounted during a the tire test, to effectively counteract such frequencies. Such tuning may be accomplished by varying factors such as the amount, configuration and placement of mass 46, the spring constant and configuration of spring 48, and the volume, placement, composition and structural configuration of damping material 50. Moreover, when two dampers 26, 60 are used in pairs, they need not be identical. For example, the two passive dampers 26 on left and right sides (or two passive dampers 26 on front and rear) may be tuned to different frequencies to have different effects depending on whether the tire and wheel assembly is accelerating or decelerating, for example.

The reduction of mechanical vibrations experienced by the machine 20 due to the use of the disclosed tuned mass damper assembly can prevent damage and structural failure of its components. Such management of vibrations is especially important for the protection of very sensitive components such as a load cell 32 and its transducers, which measure forces experienced by a tire and wheel assembly 24 during a test. With advances in vehicle technology, tires are expected to endure higher radial forces and torque than before. For example, electric vehicles in particular have heavy battery components, leading to higher weight loads. Cars are more powerful than ever, and drivers demand high levels of response and control with generally stickier tires. A tuned mass damper assembly of the current disclosure may include only a single damper 26, 60 or any number, combination and placement of disclosed dampers 26, 60 to reduce the effects of vibrations experienced by testing machine 20 or load cell 32.

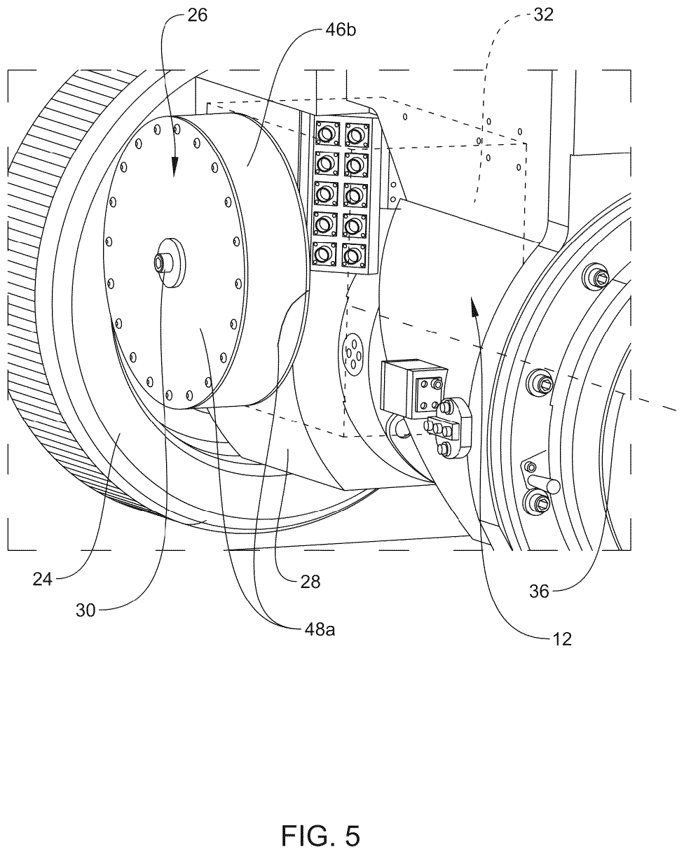

Non-limiting, exemplary embodiments of a vibration damper, assembly, and machine are described. As shown in FIGS. 5-6C exemplary embodiments of a vibration damper 26 comprise first and second diaphragm flexures 48 defining a cavity 76 therebetween, a damping material 50 disposed in the cavity 76, and a mass 46 connecting the first and second diaphragm flexures 48. In an exemplary embodiment, the damping material 50a is in particulate or particle form. In an exemplary embodiment, at least one of the first and second diaphragm flexures 48 comprises a stack 48b, 66 comprising a plurality of layers. In an exemplary embodiment, the plurality of layers comprise a metallic first layer 48c, a viscoelastic intermediate layer 50b, and a metallic second layer 48c disposed on a side of the intermediate layer 50b opposite the metallic first layer 48c.

In an exemplary embodiment, the mass 46b is configured as a cylinder, each of the first and second diaphragm flexures 48 is configured as a disc mounted to opposed ends of the cylinder, and the cavity 76 is defined within the cylinder. In an exemplary embodiment, a central shaft 46a disposed inside of the cylinder mass 46b.

In an exemplary embodiment, an assembly as shown in FIG. 5 comprises a load cell body 32 having two opposed sides and a first vibration damper 26, 60 operably connected to the load cell body 32 at the first side. In an exemplary embodiment, the vibration damper 26 comprises a spring 48, a damping material 50 and a first mass 46. In an exemplary embodiment, the assembly also includes a second vibration damper 26, 60 operably connected to the load cell body 32.

In an exemplary embodiment of the assembly, the damping material 50 is in particle form. In an exemplary embodiment of the assembly, the spring 48 comprises a diaphragm flexure 48a, 48b. In an exemplary embodiment of the assembly, the second vibration damper 60 comprises an actuator 70, a velocity sensor 72 and a second mass 46d.

An exemplary machine 20 configured to test a tire and wheel assembly 24 comprises a road surface simulator 14, a spindle drive assembly 12 and a first damper 26, 60 disposed on the spindle support 56 or spindle drive assembly 12. In an exemplary embodiment, the spindle drive assembly 12 comprises a spindle hub 34 on which the tire and wheel assembly 24 is configured to be mounted to contact the road surface simulator 14. In an exemplary embodiment, the first damper 26 comprises a first damping material 50, a first spring 48 and a first mass 46.

In an exemplary machine 20, motion of the tire and wheel assembly 24 relative to the road surface simulator 14 is configured to be primarily in opposed fore and aft linear directions 40. An exemplary machine comprises a second damper 26, 60, wherein the first damper 26, 60 is disposed on a fore side of the hub 34 and the second damper 26, 60 is disposed on an aft side of the hub 34. In an exemplary machine, a spring 48 of a damper 26 comprises a pair of diaphragm flexures 48a, 48b spaced apart in the fore and aft linear directions 40.

An exemplary machine 20 comprises a frame member 52 movably mounted to the road surface simulator 14. An exemplary machine 20 comprises a spindle support 56 that is connected to the spindle drive assembly 12 and is pivotally connected to the frame 52. An exemplary machine 20 comprises a second damper 26, 60 disposed on the spindle support 56. In an exemplary machine 20, the second damper 26 comprises a second damping material 50, a second spring 48 and a second mass 46. In another embodiment, the second damper 60 comprises an actuator 70, motion sensors 72 and/or 73, a controller 75 and a second mass 46d. In an exemplary machine 20, the spindle support 56 has opposed front and rear surfaces, and the machine 20 comprises a third damper 26, 60 disposed on the spindle support opposite the second damper 26, 60.

As shown in FIGS. 9 and 10, an exemplary machine 20 comprises a second damper 26, 60 disposed proximate an end of the spindle drive assembly 12 opposite the hub 34. In the illustrated embodiment, a second damper 60 disposed on the spindle drive assembly 12 comprises an actuator 70, motion sensors 72 and/or 73, a controller 75 and a second mass 46d.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims. In addition, any feature disclosed with respect to one embodiment may be included in another embodiment, and vice-versa. All references mentioned in this disclosure are hereby incorporated by reference.

1. A vibration damper comprising:
first and second diaphragm flexures defining a cavity therebetween;
a damping material disposed in the cavity; and
a mass connecting the first and second diaphragm flexures.

2. The vibration damper of claim 1, wherein the damping material is in particle form.

3. The vibration damper of claim 1, wherein at least one of the first and second diaphragm flexures comprises a stack comprising a plurality of layers.

4. The vibration damper of claim 3, wherein the plurality of layers comprise:
a first layer;
a viscoelastic intermediate layer; and
a second layer disposed on a side of the viscoelastic intermediate layer opposite the first layer.

5. The vibration damper of claim 1, wherein:
the mass is configured as a cylinder;
each of the first and second diaphragm flexures is configured as a disc mounted to opposed ends of the cylinder; and
the cavity is defined within the cylinder.

6. The vibration damper of claim 5 comprising a central shaft disposed within the cylinder.

7. An assembly comprising:
a load cell body; and
a first vibration damper operably connected to the load cell body at a first side of the load cell body, the first vibration damper comprising:
a spring;
a damping material; and
a first mass; and
a second vibration damper operably connected to the load cell body.

8. The assembly of claim 7, wherein the damping material is in particle form.

9. The assembly of claim 7, wherein the spring comprises a diaphragm flexure.

10. The assembly of claim 7, wherein the second vibration damper comprises:
an actuator;
a velocity sensor; and
a second mass.

11. A machine configured to test a tire and wheel assembly, the machine comprising:
a road surface simulator;
a spindle hub configured to support the tire and wheel assembly upon the road surface simulator;
a spindle housing supporting the spindle hub for rotation about an axis;
a frame;
a spindle support joined to the frame and the spindle housing; and
a damper assembly joined to the spindle housing or to the spindle support and configured to attenuate forces or motions of the spindle hub or the spindle support.

12. The machine of claim 11 wherein the damper assembly comprises
a first passive damper comprising:
a first damping material;
a first spring; and
a first mass.

13. The machine of claim 11 wherein the damper assembly comprises a first active damper comprising:
a first motion sensor configured to sense motion of the spindle housing or the spindle support;
a mass;
an actuator configured to move the mass;
a second motion sensor configured to sense motion of the mass; and
a controller receiving output signals from the first and second motion sensors and configured to provide a control signal to operate the actuator.

14. The machine of claim 11 wherein the damper assembly is configured to attenuate forces along the axis of rotation of the spindle hub.

15. The machine of claim 11 wherein the damper assembly is configured to attenuate forces in a direction orthogonal to the axis of rotation of the spindle hub.

16. The machine of claim 15 wherein the direction orthogonal to the axis of rotation of the spindle hub is parallel to a surface of the road surface simulator supporting the tire.

17. The machine of claim 11, wherein motion of the tire and wheel assembly relative to the road surface simulator is configured to be primarily in opposed fore and aft linear directions, the damper assembly comprising:
a first damper disposed on a fore side of the spindle hub; and
a second damper disposed on an aft side of the spindle hub.

18. The machine of claim 17, wherein at least one of the first and second dampers comprises a pair of diaphragm flexures spaced apart in the fore and aft linear directions.

19. A method of testing a tire and wheel assembly, comprising:
mounting the tire and wheel assembly on a spindle hub configured to support the tire and wheel assembly upon a road surface simulator, wherein a spindle housing supports the spindle hub for rotation about an axis, and wherein a spindle support is joined to the spindle housing;
operating the spindle hub to rotate the tire and wheel assembly against the road surface simulator; and
mounting a damper to the spindle housing or to the spindle support to attenuate forces or motions of the tire and wheel assembly upon the road surface simulator.

20. The method of claim 19, wherein the damper comprises a passive damper, the method comprising actuating a separate active damper.
